(19) United States
(12) Patent Application Publication
(10) Pub. No.: US 2024/0111859 A1
(43) Pub. Date: Apr. 4, 2024

(54) LOG DETERMINATION DEVICE, LOG DETERMINATION METHOD, LOG DETERMINATION PROGRAM, AND LOG DETERMINATION SYSTEM

(71) Applicant: DENSO CORPORATION, Kariya-city (JP)

(72) Inventors: Tomonori IKUSE, Kariya-city (JP); Keita HAYAKAWA, Kariya-city (JP)

(21) Appl. No.: 18/473,373

(22) Filed: Sep. 25, 2023

(30) Foreign Application Priority Data
Sep. 30, 2022 (JP) 2022-157425

(51) Int. Cl. G06F 21/55

(52) U.S. Cl. CPC G06F 21/552; G06F 21/554

(57) ABSTRACT

A log determination device is configured to acquire a plurality of security logs each including an abnormality information and a position information, store an occurrence pattern of a security log which is predicted to occur due to a maintenance, and compare the plurality of security logs with the occurrence pattern to determine whether or not the plurality of security logs is a false positive log.

### CROSS REFERENCE TO RELATED APPLICATION

This application is based on Japanese Patent Application No. 2022-157425 filed on Sep. 30, 2022, the disclosure of which is incorporated herein by reference.

### TECHNICAL FIELD

The present disclosure relates to a log determination device, a log determination method, a log determination program, and a log determination system.

### BACKGROUND

A related art discloses a device that prevents intrusion of unauthorized information by determining, when an electronic control unit detects an abnormality, a measure for blocking the unauthorized information by using a determination result as to whether a protection function or a function other than the protection function installed in the electronic control unit is normal or abnormal.

### SUMMARY

According to one example of the present disclosure, a log determination device may be configured to acquire a plurality of security logs each including an abnormality information and a position information, store an occurrence pattern of a security log which is predicted to occur due to a maintenance, and compare the plurality of security logs with the occurrence pattern to determine whether or not the plurality of security logs is a false positive log.

### BRIEF DESCRIPTION OF DRAWINGS

Objects, features and advantages of the present disclosure will become more apparent from the following detailed description made with reference to the accompanying drawings. In the drawings:

FIG. 1A is an explanatory diagram for explaining the arrangement of a log determination device and an electronic control device system of each embodiment;

FIG. 1B is an explanatory diagram for explaining the arrangement of a log determination device and an electronic control device system of each embodiment;

FIG. 1C is an explanatory diagram for explaining the arrangement of a log determination device and an electronic control device system of each embodiment;

FIG. 2 is an explanatory diagram illustrating a configuration of an electronic control system and an electronic control device according to each embodiment;

FIG. 3 is an explanatory diagram illustrating a security log generated by a security sensor of an electronic control device according to each embodiment;

FIG. 4 is a block diagram showing a configuration example of a log determination device according to the first embodiment;

FIG. 5 is a diagram for explaining information saved in a log storage unit according to the first embodiment;

FIG. 6 is a diagram for explaining information stored in a pattern storage unit according to the first embodiment;

FIG. 7 is a diagram for explaining information stored in a pattern storage unit according to the first embodiment;

FIG. 8 is a diagram illustrating an operation of the log determination device according to the first embodiment;

FIG. 9 is a diagram for explaining the operation of the log determination device of the first embodiment;

FIG. 10 is a block diagram showing a configuration example of a log determination device according to the second embodiment;

FIG. 11A is a diagram for explaining a log determination method according to the second embodiment;

FIG. 11B is a diagram for explaining a log determination method according to the second embodiment;

FIG. 11C is a diagram for explaining a log determination method according to the second embodiment;

FIG. 11D is a diagram for explaining a log determination method according to the second embodiment;

FIG. 11E is a diagram for explaining a log determination method according to the second embodiment;

FIG. 12A is a diagram for explaining a log determination method according to the second embodiment;

FIG. 12B is a diagram for explaining a log determination method according to the second embodiment;

FIG. 12C is a diagram for explaining a log determination method according to the second embodiment;

FIG. 12D is a diagram for explaining a log determination method according to the second embodiment;

FIG. 12E is a diagram for explaining a log determination method according to the second embodiment;

FIG. 13 is a diagram for explaining the operation of the log determination device according to the second embodiment; and

FIG. 14 is a diagram for explaining the operation of the log determination device according to the second embodiment.

### DETAILED DESCRIPTION

The inventors of the present application have found the followings. In recent years, technologies for driving support and autonomous driving control, including V2X such as vehicle-to-vehicle communication and road-to-vehicle communication, have been attracting attention. Vehicles have come to be equipped with a communication function, and vehicles are becoming more connected. A probability that a vehicle receives a cyberattack such as unauthorized access may increase. Therefore, it may be required to analyze a cyber-attack on a vehicle and take a countermeasure against the cyberattack.

As a result of detailed consideration by the inventors, the inventors found the following.

The abnormality that occurs in the vehicle includes not only an abnormality that occurs due to a cyberattack but also an abnormality that occurs for a reason other than the cyberattack. For example, when vehicle maintenance is performed, the electronic control system is in a different state during or immediately after the maintenance, causing sensors to detect abnormal conditions and generate a log accordingly. Therefore, the collected logs may contain not only logs related to abnormalities caused by cyberattacks, but also logs related to abnormalities caused by such maintenance. There is a possibility that they are mixed together. When the analysis of the cyberattack is performed in a state in which such logs are mixed, the analysis accuracy may decrease.

The present disclosure describes a technique to determine whether or not a log generated by a sensor is a log generated by performing maintenance.

According to one aspect of the present disclosure, a log determination device may include: a log acquisition unit that is configured to acquire a plurality of security logs each including an abnormality information indicating an abnormality detected in an electronic control system and a position information indicating a position of the abnormality in the electronic control system; a pattern storage unit that is configured to store an occurrence pattern of a security log which is predicted to occur due to a maintenance of the electronic control system, the occurrence pattern including a plurality of sets each including a prediction abnormality information indicating an abnormality which is predicted to be detected in the electronic control system and a prediction abnormality position information indicating a position of the abnormality that is predicted to be detected in the electronic control system; and a false positive log determination unit that is configured to compare the plurality of security logs with the occurrence pattern, determine whether or not the plurality of security logs is a false positive log generated by detecting an abnormality caused by the maintenance.

According to the configuration as described above, it is possible to determine whether or not the log generated by the electronic control system is a log related to an abnormality caused by vehicle maintenance. It is possible to analyze the cyberattack in consideration of the determination result. It is possible to improve the accuracy of cyber-attack analysis.

Hereinafter, embodiments of the present disclosure will be described with reference to the drawings.

When there are multiple embodiments, a configuration disclosed in each embodiment may not be limited to each embodiment, alternatively, configurations can be combined across embodiments. For example, a configuration disclosed in one embodiment may be combined with other embodiments. The disclosed configurations in respective multiple embodiments may be partially combined.

### Configuration Based on Embodiments

(Arrangement of a Log Determination Device 10 and an Electronic Control System S)

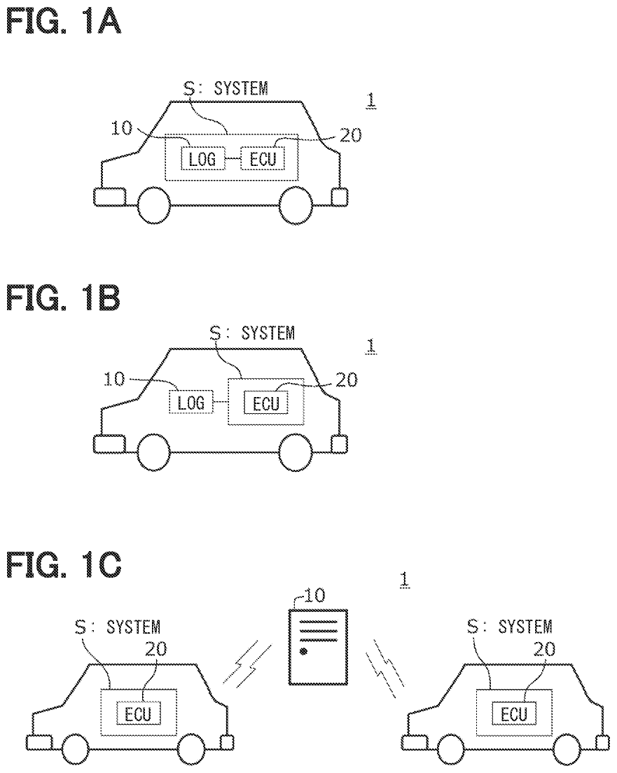

A log determination system 1 is a system including a log determination device 10 and an electronic control device 20 configuring an electronic control system S. The arrangement of the log determination device 10 of each embodiment configuring the log determination system 1 will be described with reference to FIGS. 1A to 1C. For example, as illustrated in FIG. 1A and FIG. 1B, it is assumed that the log determination device 10 is “mounted” on a vehicle which is a “movable object” together with the electronic control device 20 configuring the electronic control system S. As illustrated in FIG. 1C, it is assumed that the electronic control device 20 configuring the electronic control system S is “mounted” on a vehicle, which is a “movable object” and that the log determination device 10 is implemented by a server device, a security operation center (SOC), or the like provided outside the vehicle.

The term “movable object” may be referred to as a moving object, and a travel speed is arbitrary. The movable object may be also referred to as a moving body, a mobile body, a mobile object, or the like. In addition, a case in which the movable object is stopped is also included. Examples of the movable object include automobiles, motorcycles, bicycles, pedestrians, ships, aircrafts, and objects mounted thereon. However, the movable object is not limited to these features.

Further, the term “mounted” includes not only a case where an object is directly fixed to the movable object but also a case where an object is moved together with the movable object although the object is not fixed to the movable object. Examples of the in-vehicle device include a case in which a device carried by a person in the movable object, and a case in which a device mounted on a load placed in the movable object.

In the example illustrated in FIG. 1A, the log determination system 1 may be referred to be an electronic control system S. Further, in the example shown in FIG. 1C, the log determination system 1 is a system including a log determination device 10 provided outside the vehicle and the respective electronic control systems S mounted on multiple vehicles.

The log determination device 10 is a device that acquires security logs from multiple electronic control units (ECUs) 20 that configures the electronic control system S and determines the acquired security logs.

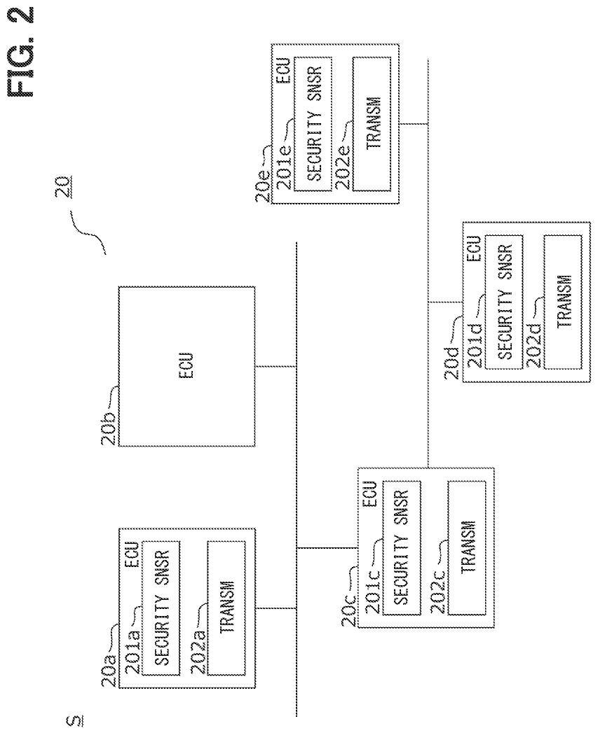

FIG. 2 is a diagram showing a configuration example of the electronic control system S. The electronic control system S includes multiple ECUs 20. Although FIG. 2 exemplifies five ECUs (ECUs 20a to 20e), the electronic control system S may include any number of ECUs. In the following description, the ECU 20 or each ECU 20 will be used when describing a single or a plurality of electronic control units as a whole, and the ECU 20a, ECU 20b, ECU 20c, etc. when describing individual electronic control units will be described.

In the electronic control system S shown in FIG. 2, the ECUs 20a, 20c, 20d, and 20e each have a security sensor 201. By contrast, no security sensor is mounted on the ECU 20b. When security sensors are installed on multiple ECUs 20 that make up the electronic control system S, it is not necessary for all ECUs 20 to have security sensors. Alternatively, all ECUs 20 may have security sensors. Each ECU 20 also has a log transmission unit 202 that sends the security logs generated by the security sensor.

The security sensor 201 (corresponding to a log generation unit) generates security logs when the security sensor 201 detects abnormality occurring within the electronic control system, such as within the ECU 20 or network connected to the ECU 20. A security sensor that monitors communication on the network in the electronic control system S and detects abnormality in communication content and communication frequency is called a network-based IDS (Intrusion Detection System).

The log transmission unit 202 “transmits” the security log generated by the security sensor 201 to the log determination device 10.

Here, the term “transmitting” may be transmitted using either wired communication or wireless communication. Transmission using wireless communication also includes transmission via a device having a communication function.

In each embodiment described below, a case where the security log is a log generated by the security sensor 201 illustrated in FIG. 2 will be described as an example. However, the security log in the present disclosure may be a log generated by a function of collecting and managing information related to an event that has occurred in the electronic control system, which is called an in-vehicle SIEM (Security Information and Event Management).

The electronic control system S can be configured by any ECU. The electronic control unit (ECU) may be, for example, a drive system electronic control device that controls an engine, a steering wheel, a brake, etc. The ECU may be, for example, a vehicle-body electronic control device that controls a meter, and a power window, etc. The ECU may be, for example, an information-system electronic control device such as a navigation device. The ECU may be, for example, a safety-control electronic control device that controls to prevent a collision with an obstacle or a pedestrian. The ECUs may be in parallel relationship with each other. Alternatively, the ECUs may be classified as masters and slaves. The electronic control system S may be provided with a gateway ECU or a central ECU (referred to as a C-ECU) that connects the electronic control units to each other, and an external communication ECU that communicates with the outside of the vehicle. For example, the ECU 20a may be an external communication ECU. The ECU 20c may be the C-ECU. Also, to prevent third-party impersonation, message authentication may be used for communication between ECUs 20. Further, the ECU 20 may be a physically independent ECU. The ECU 20 may be a virtual ECU (may be referred to as a virtual machine) that is virtually realized.

In the case of FIG. 1A and FIG. 1B, the log determination device 10 and each ECU 20 are connected via an in-vehicle communication network such as a controller area network (CAN) or a local interconnect network (LIN). Alternatively, the log determination device 10 and each ECU 20 may be connected via any communication method, whether wired or wireless, such as Ethernet (registered trademark), Wi-Fi (registered trademark), or Bluetooth (registered trademark). The term “connection” may refer to a state in which data can be exchanged. This state includes a case in which different hardware devices are connected through a wired or wireless communication network, as well as a case in which virtual machines running on the same hardware are virtually connected.

FIG. 1A illustrates a log determination device 10 is independently provided inside the electronic control system S, or a function of the log determination device 10 is incorporated in at least one of the ECUs 20 configuring the electronic control system S, for example, a C-ECU or an external communication ECU.

FIG. 1B is a diagram in which the log determination device 10 is provided outside the electronic control system S. FIG. 1B is substantially the same as FIG. 1A from the viewpoint of the form of connection.

In the case of FIG. 1C, a log determination device 10 is also provided outside the electronic control system S. Since the log determination device 10 is located outside the vehicle, the connection method is different from that of FIG. 1A and FIG. 1B. The log determination device 10 and the electronic control system S are connected via a communication network such as a wireless communication system such as IEEE 802.11 (Wi-Fi (registered trademark)), IEEE 802.16 (WiMAX (registered trademark)), W-CDMA (Wideband Code Division Multiple Access), HSPA (High Speed Packet Access), LTE (Long Term Evolution), LTE-A (Long Term Evolution Advanced), 4G, or 5G. Alternatively, dedicated short range communication (DSRC) may be used. When the vehicle is parked in a parking lot or housed in a repair shop, a wired communication system may be used instead of a wireless communication system. For example, a local area network (LAN), the Internet, or a fixed telephone line may be used. Incidentally, even when the vehicle is parked in a parking lot or housed in a repair shop, the log determination device 10 and the electronic control system S may be connected via a wireless communication system.

In the case of FIG. 1C, one ECU (for example, the ECU 20a) among the ECUs 20 aggregates security logs generated by the security sensor 201 of each ECU 20, and collectively transmits the aggregated security logs to the log determination device 10. The ECU 20a in this case corresponds to an intrusion detection system reporter (IDSR) of a specification defined by an automatic open system architecture (AUTOSAR). Alternatively, the ECU 20a may sequentially transmit the security log generated by the security sensor of each ECU 20 to the log determination device 10.

In the case of FIG. 1A and FIG. 1B, the log determination process is performed in the vehicle. It may be possible to transmit only a security log that is not determined to be a false positive log to a server device or the like provided outside the vehicle. In other words, a false positive log is not transmitted to the outside of the vehicle such as a server, which may be referred to as a server device. Therefore, it may be possible to reduce the amount of communication between the vehicle and the server device. Further, since the server device may analyze only the security log other than the received false positive log, it may be possible to suppress the log analysis process in the server device.

In the case of FIG. 1C, the log determination process can be executed using the abundant resources of the server apparatus. Further, it may be possible to implement the log determination process of each embodiment without installing a new device or a new program in an existing vehicle.

In the following embodiments, a case of the arrangement shown in FIG. 1C will be described as an example.

In each embodiment, the electronic control system S will be described with an example that the electronic control system S corresponds to an in-vehicle system installed in a vehicle. The electronic control system S is not limited to an in-vehicle system but may be applied to any electronic control system configured by multiple ECUs. For example, the electronic control system S may be mounted on a stationary object instead of a movable object.

Although not illustrated in FIG. 1A and FIG. 1B, the log determination device 10 may be further connected to an attack analysis device (not illustrated) that analyzes a security log determined by the log determination device 10 and analyzes a cyberattack performed on a vehicle. Alternatively, each function of the log determination device 10 may indicate a function incorporated in the attack analysis device. The cyberattack may be referred to as an attack.

In addition, in FIG. 1A to FIG. 1C and the above description related to these drawings, the log determination device 10 of the first embodiment is taken as an example, but each arrangement can also be applied to a log determination device 11 of a second embodiment.

(Details of a Security Log)

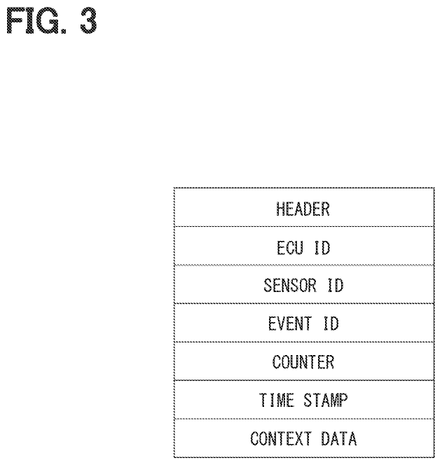

FIG. 3 is a diagram showing an example of contents of a security log generated by the security sensor 201 of the ECU 20.

The security log contains an ECU-ID (corresponding to position information) indicating identification information of an ECU on which the security sensor 201 is mounted, a sensor ID indicating the identification information of the security sensor, and an event ID (corresponding to abnormality information) indicating the identification information of the event detected by the security sensor. The security log further contains a counter indicating the number of times the event has been detected, a time stamp (corresponding to time information) indicating the time when the event is detected, and context data indicating the details of an output of the security sensor. The security log may further include a header (may be referred to as a header data, a header information, or the like) storing information indicating a version of a protocol and a state of each field.

According to the specification defined by AUTOSAR, IdsM Instance ID corresponds to an ECU-ID, Sensor Instance ID corresponds to the sensor ID, Event Definition ID corresponds to the event ID, Count corresponds to the counter, Timestamp corresponds to the timestamp, Context Data corresponds to the context data, and Protocol Version or Protocol Header corresponds to the header.

When the security sensor 201 detects an abnormality in the electronic control system, the security sensor 201 generates the security log as shown in FIG. 3 including the event ID indicating the detected abnormality.

In each embodiment, the event ID corresponds to information indicating an abnormality detected in the electronic control system, and the ECU-ID is used as information indicating the “position” in the electronic control system where the abnormality is detected. The configuration for determining the security log will be described with the event ID and the ECU-ID. However, the information used by the log determination device 10 for the security log determination is not limited to the event ID and the ECU-ID. For example, information stored in the context data may be used as information indicating abnormality detected within the electronic control system. A sensor ID may also be used as information indicating the position within the electronic control system where an abnormality has been detected. Alternatively, if an anomaly is detected in the network, the identity of the network in which the anomaly occurred may be used.

Here, the term “position” corresponds to an individual electronic control unit, a function mounted on the electronic control unit, or a network position, for example.

FIG. 3 is an example of a log generated when an abnormality occurs, but a normal log generated when no abnormality occurs (for example, when an event succeeds) may have the same specifications as in FIG. 3. In such a case, different event IDs may be used for an abnormal event and a successful event to distinguish between the abnormality log and the normal log. Alternatively, by setting a flag indicating the presence or absence of context data in the header, the abnormal log may be distinguished from the normal log by checking the flag.

FIG. 3 shows a security log generated by the ECU 20 that is physically independent. The security log may be generated by a virtual ECU.

### Examples of Security Logs Generated by Maintenance

When performing maintenance on the electronic control system S mounted on the vehicle, the security sensor 201 is expected to generate a specific security log according to the content of the maintenance. Therefore, examples (a) to (d), which are described below, of maintenance on the electronic control system S and security logs expected to be generated by these maintenances will be described below. The contents of the maintenance of the electronic control system S and the security log generated by the maintenance are merely examples and are not limited to these.

### (a) First Example of a Maintenance (ECU Replacement)

An example of the maintenance in which the ECU 20 (for example, the ECU 20c) configuring the electronic control system S is replaced with the ECU 20c2 at a repair shop or a dealer will be described. ECU 20c is an ECU which transmits a message to other ECU 20 periodically. In replacing the ECU 20, it is assumed that the maintenance worker (an operator) performs the following works (i) to (v).

The work (i) includes replacing the ECU 20c with the ECU 20c2 by the maintenance worker. The work (ii) includes, after the work of (i) is completed, tuning on the power of the vehicle to check whether the ECU 20c2 operates normally, and accessing to the ECU 20c2 using the initial value of authentication information of the ECU 20c2. The work (iii) includes synchronizing the ECU 20c2 with another ECU 20 (for example, the ECU 20d) that performs message authentication using the common key with the ECU 20c2 to set a new common key to the ECU 20c2 and the ECU 20d. The work (iv) includes setting the authentication information of the ECU 20c2 to the new authentication information from the initial value, which is low security. The work (v) includes accessing the ECU 20c2 using the initial value of the authentication information to confirm that the change of the authentication information has been completed. When the ECU 20c2 cannot be accessed using the initial value of the authentication information, it is considered that the change of the authentication information of the ECU 20c2 is completed.

By turning on the power of the vehicle in the above work (ii), the ECU 20c2 transmits periodic messages to the ECU 20d. At this time, the common key held by the ECU 20c2 after replacement and the ECU 20d is different, so the security sensor 201d of the ECU 20d detects an abnormality indicating a key mismatch and generates a security log (a1).

In addition, through the above operation (v), the security sensor 201c of the ECU 20c detects an abnormality indicating access using the authentication information (the initial value of the authentication information) different from the normal authentication information, and a security log (a2) is generated.

As described above, it is predicted that the security logs (a1) and (a2) will be generated due to the replacement maintenance of the ECU 20c.

### (b) Second Example of a Maintenance (Software Change)

An example of maintenance for changing settings of software installed in the ECU 20 will be described. Specifically, regarding the software installed in the ECU 20 (e.g., the ECU 20e) and periodically transmits messages to other ECUs 20, a case of changing the message transmission cycle will be described as an example.

While the settings of the software installed in the ECU 20e are being changed, the software cannot communicate. Therefore, the security sensor 201 mounted on another ECU 20 connected to the ECU 20e uses, for example, a life-and-death monitoring function to detect an abnormality indicating that the ECU 20e is not operating and generates a security log (b1).

After the setting change of the software of the ECU 20e is completed, the software of the ECU 20e restarts message transmission. However, since the communication cycle of data sent and received on the in-vehicle network is different from before the setting change, the security sensor 201 (for example, the security sensor 201c) that monitors the network detects such a change in the communication cycle as abnormality and generates a security log (b2).

Here, by adjusting the setting of the security sensor 201c so as not to detect the changed communication cycle as abnormality, the security sensor 201c will not detect the change in the communication cycle as abnormality. However, another security sensor 201 (for example, the security sensor 201d) detects that the setting in the security sensor 201c has been adjusted and generates a security log (b3).

As described above, security logs (b1), (b2) and (b3) are expected to be generated by maintenance that changes the settings of the software of the ECU 20e.

### (c) Third Example of a Maintenance (Addition of ECU)

An example of maintenance for adding the ECU 20 (for example, an ECU 20f) to the electronic control system S will be described.

When a new ECU 20f is added to the electronic control system S, the data transmitted by the ECU 20f is communicated to the other ECUs 20 via the in-vehicle network. Since this data does not exist before the addition of the ECU 20f, the security sensor 201 (for example, the security sensor 201c) detects as abnormality that data which has never been communicated on the in-vehicle network is transmitted and generates a security log (c1).

Here, by adjusting the settings of the security sensor 201c so that the data communication by the newly added ECU 20f is not detected as abnormality, and the security sensor 201c does not detect the abnormality. However, another security sensor 201 (for example, the security sensor 201d) detects as abnormality that the setting has been adjusted in the security sensor 201c and generates a security log (c2).

As described above, it is predicted that security logs (c1) and (c2) will be generated by maintenance for adding a new ECU 20 to the electronic control system S.

In this example, an example of maintenance when an ECU is added has been described, but it is expected that a similar security log will be generated when a new software is added to the ECU 20 as well.

### (d) Forth Example of a Maintenance (Deletion of ECU)

An example of maintenance in which the ECU 20 (for example, the ECU 20e) is removed from the electronic control system S will be described.

When the ECU 20e is deleted from the electronic control system S, the security sensor 201c detects as abnormality that data from the ECU 20e that should be communicated on the in-vehicle network is not communicated and generates a security log (d1).

Similar to the example (c), by adjusting the settings of the security sensor 201c, the security sensor 201c will not detect the abnormality. However, another security sensor 201 (for example, the security sensor 201d) detects as the abnormality that the setting in the security sensor 201c has been adjusted and generates a security log (d2).

As described above, security logs (d1) and (d2) are expected to be generated by maintenance that deletes ECU from the ECU 20.

In this example, an example of maintenance when an ECU is removed has been described, but it is expected that a similar security log will be generated when a software is deleted from the ECU 20 as well.

### First Embodiment

(Configuration of the Log Determination Device 10)

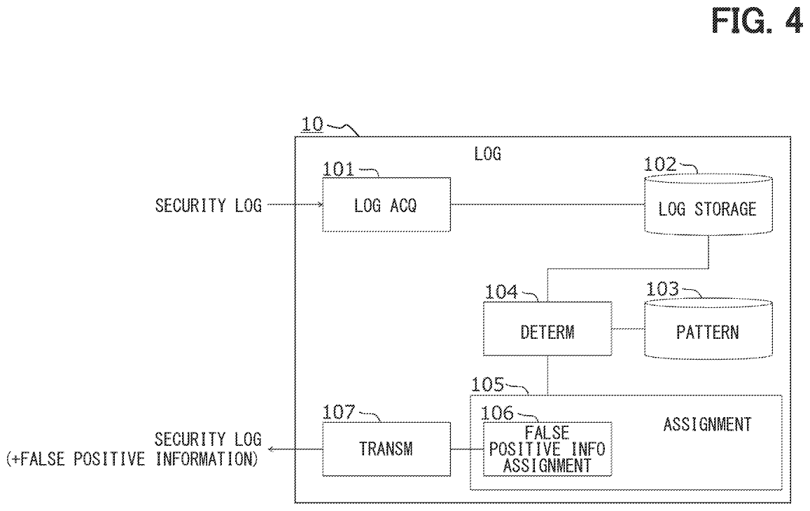

FIG. 4 is a block diagram showing the configuration of the log determination device 10 in the present embodiment. The log determination device 10 includes a log acquisition unit 101, a log storage unit 102, a pattern storage unit 103, a false positive log determination unit 104, an information assignment unit 105 and a transmission unit 107. The information assignment unit 105 of this embodiment implements a false positive information assignment unit 106.

The log acquisition unit 101 acquires a security log generated by the security sensor 201 mounted on the ECU 20. The configuration of the electronic control system S is as described in FIG. 2. The contents of the security log are as described in FIG. 3.

When the log determination device 10 adopts the arrangement shown in FIG. 1C, the log acquisition unit 101 acquires the security log by receiving it via a communication network using a wireless communication method. The log acquisition unit 101 may collectively acquire multiple aggregated security logs. Alternatively, the log acquisition section 101 may acquire the generated security logs sequentially.

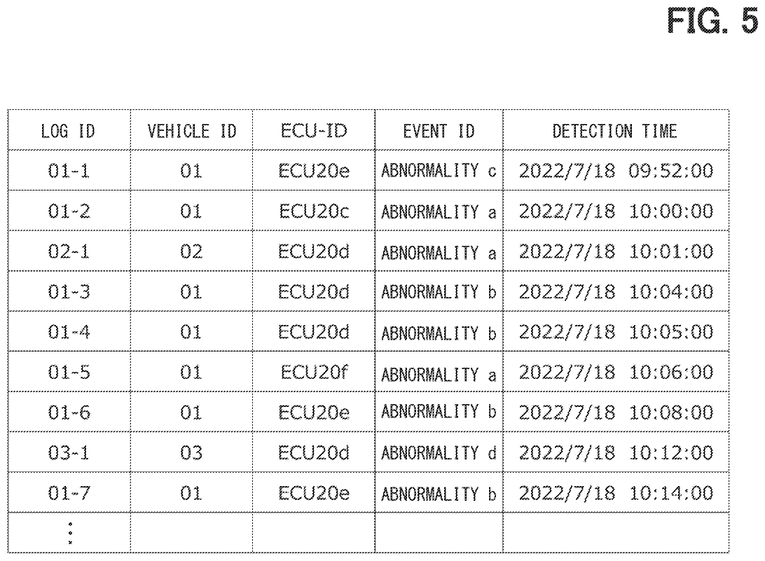

The log storage unit 102 is a storage unit that stores logs acquired by the log acquisition unit 101. FIG. 5 shows an example of information stored in the log storage unit 102. In the example shown in FIG. 5, in addition to the ECU-ID included in the security log, the event ID and detection time, the log storage unit 102 stores identification information of the vehicle (referred to as vehicle ID) equipped with the electronic control system S, log identification information (referred to as log ID) assigned to each security log. As an example, the log ID shown in FIG. 5 is represented by a combination of a vehicle ID and the order in which the log acquisition unit 101 acquires the log.

The pattern storage unit 103 is a storage unit that stores a generation pattern of security logs expected to occur due to the “maintenance” of the electronic control system S. As described above, when the electronic control system S is maintained, it is predicted that at least one certain security log will be generated according to the content of the maintenance.

Here, the term “maintenance” of the electronic control system means any changes to the electronic control devices that make up the electronic control system, the software installed in the electronic control devices, the network that connects the electronic control devices, etc. For example, deletion, addition, replacement, update, etc. of electronic control devices and the like may be mentioned.

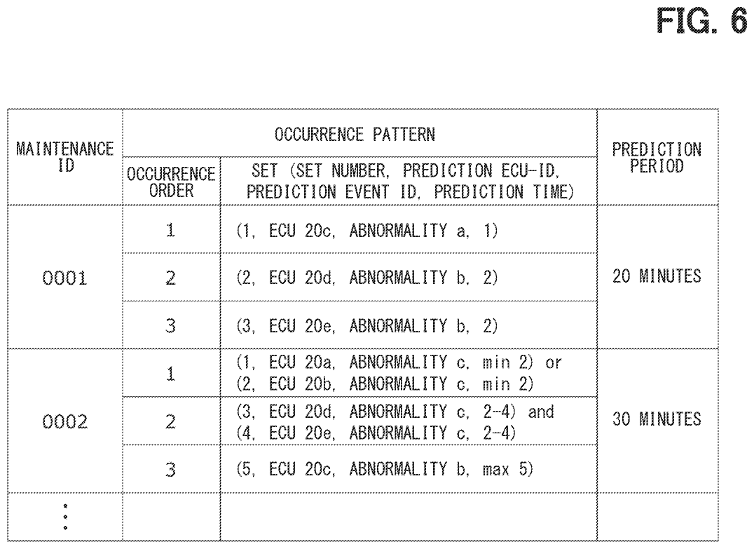

FIG. 6 shows an example of information stored in the pattern storage unit 103. In the example of FIG. 6, the pattern storage unit 103 stores maintenance identification numbers (referred to as maintenance IDs), occurrence patterns, and prediction periods. The occurrence pattern in FIG. 6 includes multiple sets that include a prediction event ID, predicted ECU ID, predicted count, and a set number, as well as the order in which multiple sets occur. The prediction event ID (corresponding to “predicted abnormality information”) indicates an abnormality predicted to be detected by the electronic control system S. The predicted ECU ID (corresponding to “predicted abnormality position information”) indicates a “position” in the electronic control system in which the predicted abnormality is detected. The predicted number of times indicates the “number of times” that the predicted abnormality will occur. Also, the prediction period shown in FIG. 6 indicates a prediction period from the time when the predicted abnormality is first detected to the time when the predicted abnormality is last detected. Note that the occurrence pattern shown in FIG. 6 is an example, and the pattern is not limited to FIG. 6. For example, the occurrence pattern may be a pattern comprised of only multiple sets including prediction event IDs and prediction ECU-IDs.

The “number of times” may be defined by a maximum value and/or a minimum value, or a range of the number of times as well as a specific value.

For example, the occurrence pattern in the case of maintenance ID (0001) shown in FIG. 6 shows that an abnormality (a) is detected at the ECU 20c once (an occurrence order: 1), and then abnormalities (b) are detected twice at the ECU 20d (an occurrence order: 2), and then abnormalities (b) are detected twice at the ECU 20e (occurrence order: 3). The prediction period for the maintenance ID (0001) is twenty minutes. This indicates that the prediction period from the time when the abnormality (a) is detected at the ECU 20c to the time when the second abnormality (b) is detected at the ECU 20e is within 20 minutes.

Further, the occurrence pattern in the case of the maintenance ID (0002) in FIG. 6 shows that the abnormalities (c) are detected twice or more at the ECU 20a or the abnormalities (c) are detected twice or more at the ECU 20b (the occurrence order: 1), and the abnormalities (c) are detected two to four times at the ECU 20d detects and the abnormalities (c) are detected two to four times at the ECU 20e (the occurrence order: 2), and the abnormalities (b) are detected up to five times at the ECU 20c (occurrence order: 3). Furthermore, the prediction period for the maintenance ID (0002) is set to thirty minutes. This indicates that the prediction period from the time when the abnormality (c) is first detected at the ECU 20a or the ECU 20b to the time when the abnormality (b) is finally detected at the ECU 20c within 30 minutes.

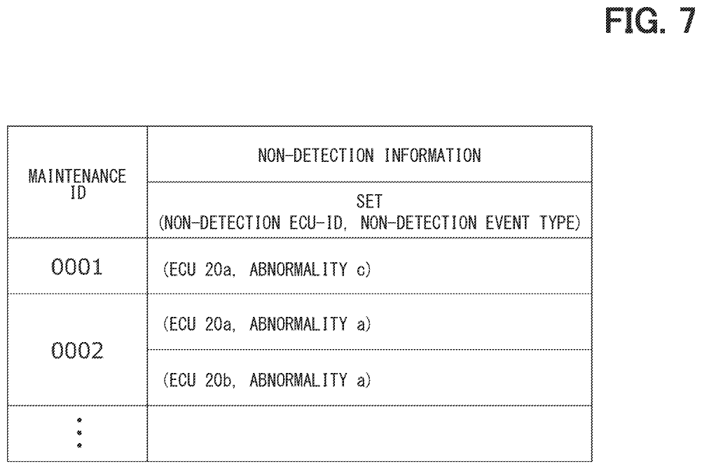

The pattern storage unit 103 may further store information related to a security log that is expected not to occur due to the maintenance of the electronic control system S (referred to as a non-detection log). FIG. 7 shows an example of information about the non-detection log stored in the pattern storage unit 103. In the example of FIG. 7, the pattern storage unit 103 stores the maintenance ID and a set including a non-detection ECU ID (corresponding to prediction non-detection position information) indicating a “position” in the electronic control system where it is predicted that an abnormality will not be detected by the maintenance and an non-detection event type (corresponding to prediction non-detection abnormality information) indicating an abnormality that is predicted not to be detected by the ECU indicated by the non-detection ECU ID.

For example, the maintenance ID (0001) shown in FIG. 7 indicates that the abnormality (c) is not detected at the ECU 20a within twenty minutes, which is the prediction period of the maintenance ID (0001) shown in FIG. 6. Further, the maintenance ID (0002) in FIG. 7 indicates that the abnormality (a) is not detected in the ECU 20a, and the abnormality (a) is not detected in the ECU 20b within thirty minutes, which is the prediction period of maintenance ID (0002).

In FIG. 6 and FIG. 7, the ECU identification information (that is, prediction ECU-ID) is used as the information indicating the position in the electronic control system. However, in the occurrence pattern, a security sensor or network identification information may be used as the information indicating the position within the electronic control system.

Incidentally, the patterns generated by the maintenance may differ depending on the type of a vehicle (for example, vehicle type, year, and model). Therefore, the pattern storage unit 103 may store the occurrence patterns and the prediction periods for each type of the vehicle.

The occurrence patterns and the prediction periods stored in the pattern storage unit 103 may be set by vehicle manufacturers, dealers, maintenance shops, and the like. For example, the occurrence pattern and the prediction period may be set based on a log recorded during trial work conducted to create maintenance procedures or to set an estimated completion time for maintenance work at a dealership or the like. Additionally, the occurrence pattern and the prediction period may be set based on security logs that resulted from an actual cyberattack or from trial attacks designed to simulate an actual cyberattack. For example, even when a security log matches the occurrence pattern which is predicted to resulted from the maintenance, to avoid that it is determined to be a false positive log, the occurrence pattern and the prediction period may be set for a security log that matches a pattern predicted to result from a cyberattack.

The false positive log determination unit 104 compares the multiple security logs and the order of occurrence of the multiple security logs stored in the log storage unit 103 with the occurrence patterns stored in the pattern storage unit 103. The false positive log determination unit 104 determines whether or not the security logs acquired by the log acquisition unit 101 is false positive logs generated due to the detection of an abnormality caused by the maintenance, and outputs a determination result. Here, the false positive log refers to a security log generated by the security sensor detecting an abnormality different from an abnormality caused by the electronic control system S being attacked. In the present disclosure, a false positive log generated by the security sensor detecting an abnormality caused by maintenance of the electronic control system S is determined.

For example, the false positive log determination unit 104 compares the content of the security log shown in FIG. 5 with the occurrence pattern shown in FIG. 6. According to FIG. 5 and FIG. 6, the ECU-ID and the event ID of the log ID [01-2] shown in FIG. 5 matches the prediction ECU-ID and the prediction event ID of the set number [1] in the maintenance ID (0001) shown in FIG. 6. The ECU-ID and the event ID of the log ID [01-3] and the log ID [01-4] and the number of security logs (that is, two) match the prediction ECU-ID, the prediction event ID and the prediction number of times of the set number [2]. Also, the ECU-ID and the event ID of the log ID [01-6] and the log ID [01-7] and the number of security logs (that is, two) match the prediction ECU-ID, the prediction event ID and the prediction number of times of the set number [3]. The order of occurrence of the log IDs [01-2], [01-3] and [01-4], [01-6] and [01-7] matches the order of occurrence of the occurrence pattern of the maintenance ID (0001).

The false positive log determination unit 104 further compares the period from the detection time of the log ID [01-2] which has the earliest detection time (10:00:00) to the detection time of the log ID [01-7] which has the latest detection time (10:14:00) among the above security logs, with the prediction period shown in FIG. 6. In this case, the period from the detection time (10:00:00) to the detection time (10:14:00) is within the prediction period.

The false positive log determination unit 104 further determines whether or not a security log corresponding to the non-detection log has been detected between the earliest detection time and the latest detection time. According to FIG. 5, no security log corresponding to the non-detection log (that is, abnormality (c) in the ECU 20a) shown in FIG. 6 is detected.

The false positive log determination unit 104 determines that security logs of the log IDs [01-2], [01-3], [01-4], [01-6], and [01-7] are false positive logs.

By contrast, among the security logs stored in the log storage unit 102, the security logs other than the log IDs described above do not match the occurrence patterns stored in the pattern storage unit 103. Therefore, the false positive log determination unit 104 determines that these security logs are not false positive logs, that is, are security logs generated by the detection of abnormality that occurred in the electronic control system S.

The false positive log determination unit 104 of the embodiment performs a false positive log determination processing periodically or at the timing when a predetermined event occurs. The timing of the predetermined event occurrence includes, for example, the timing of turning on or off the vehicle power, the timing of the vehicle performing a specific behavior, or the timing of the log acquisition unit 101 acquiring a new security log.

The block diagram shown in FIG. 4 exemplifies a configuration in which the false positive log determination unit 104 outputs a determination result to a positive information assignment unit 105. The false positive log determination unit 104 may output the determination result to a memory (not shown) such as RAM (Random Access Memory).

The information assignment unit 105 adds information to the security log based on the determination result output from the false positive log determination unit 104. The information assignment unit 105 of the present embodiment implements a false positive information assignment unit 106.

Based on the determination result output from the false positive log determination unit 104, the false positive information assignment unit 106 adds to the security log “false positive information” indicating information specifying the false positive log. When the determination result of the false positive log determination unit 104 is output and stored in a memory (not shown) such as a RAM, the false positive information assignment unit 104 adds the false positive information to the security log based on the determination result stored in the memory.

Here, the term “false positive information” refers not only to information indicating that the security log is a false positive, but also to information indicating that the security log is not a false positive.

For example, the false positive information assignment unit 106 adds a flag indicating that the security log is a false positive as false positive information to the security log that the false positive log determination unit 104 has determined as a false positive log. The false positive information may be given by being stored in the context data of the security log illustrated in FIG. 3, for example. By adding a flag as false positive information to the security log, it may be possible to easily distinguish between the security log generated by attacks and the security log generated due to the maintenance.

In the embodiment described below, a case where the false positive information assignment unit 106 adds false positive information to a security log that has been determined to be a false positive log is described. The false positive information assignment unit 106 may add the false positive information to a security log determined by the false positive log determination unit 104 not to be a false positive log. The false positive information in the latter case indicates information indicating that the security log to which the information is added is not a false positive log.

The transmission unit 107 transmits security logs that have not been determined to be false-positive logs and security logs that have been determined to be false positive logs. For example, the transmission unit 107 transmits the security logs to an attack analysis device (not shown) that analyzes the security logs. The attack analysis device that receives the security log determines whether or not the security log is a false positive log based on the false positive information added to the security log.

Alternatively, the transmission unit 107 may only transmit security logs that have not been determined to be false positives. In the case of the log determination device 10 illustrated in FIG. 1A and FIG. 1B, the amount of communication between the vehicle and the attack analysis device may be reduced by transmitting only security logs that are not determined to be false positive logs to the attack analysis device (not illustrated) provided outside the vehicle.

In addition, in the present embodiment, the transmission unit 107 is configured to transmit the security log from the log determination device 10. The transmission unit 107 may transmit the determination result by the false positive log determination unit 104 instead of or in addition to the security log.

(Operation of the Log Determination Device 10)

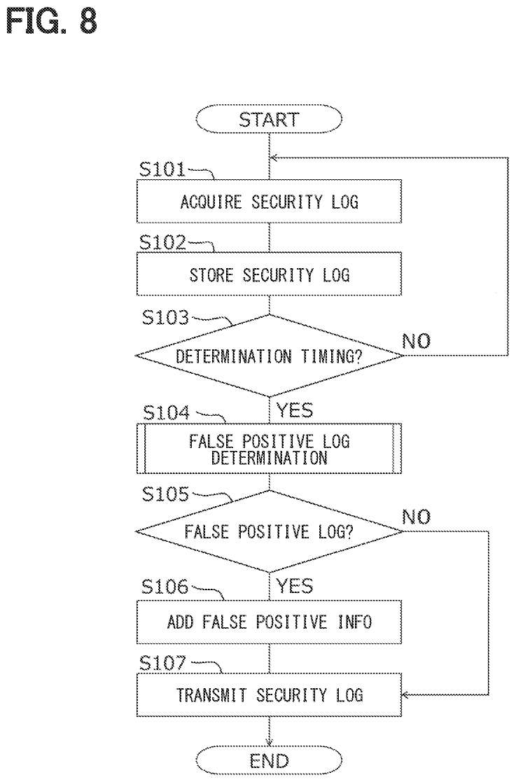

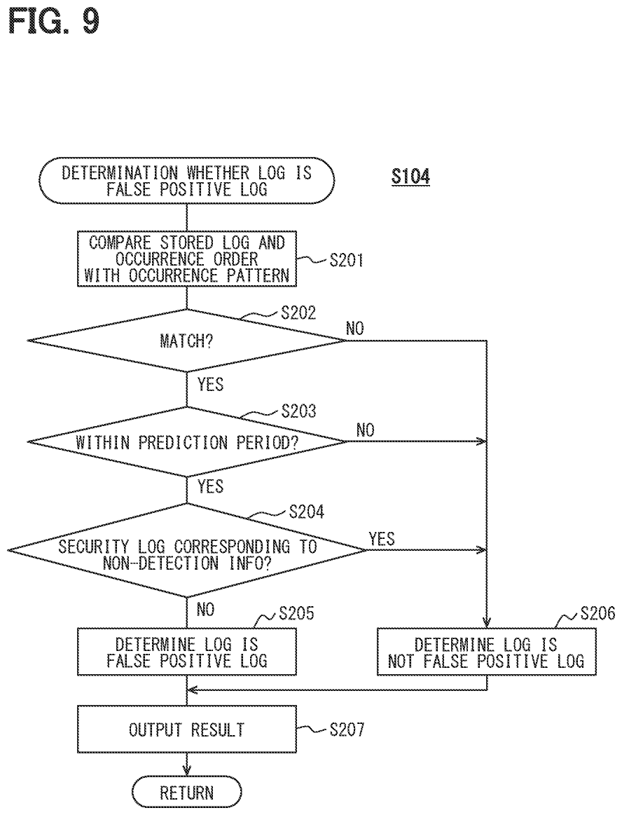

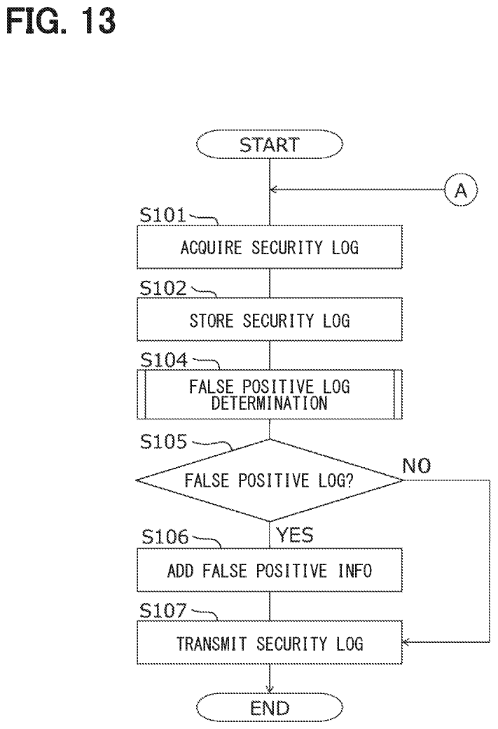

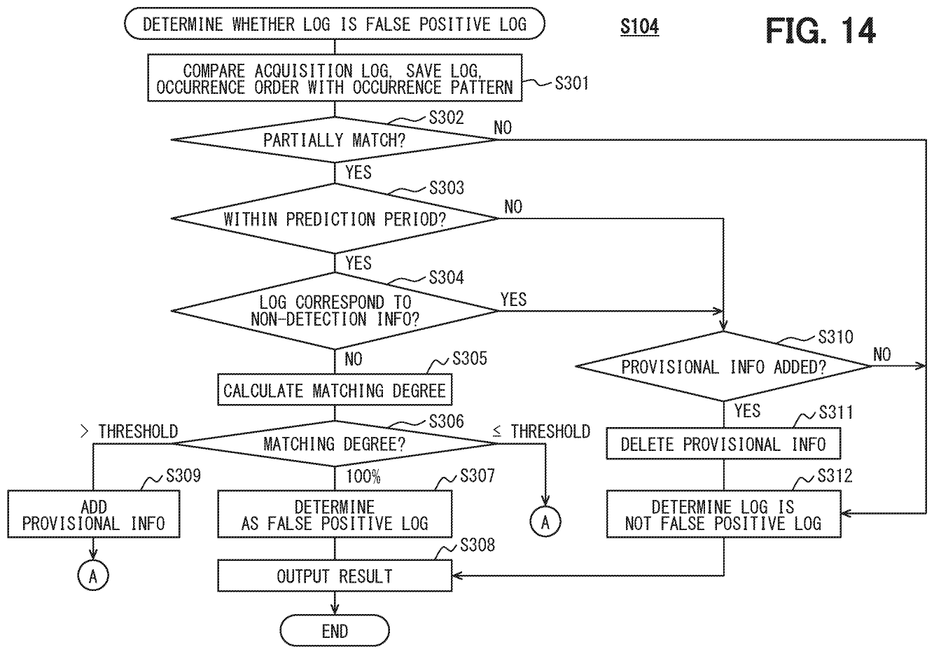

The operation of the log determination device 10 will be described with reference to FIG. 8 and FIG. 9. FIG. 8 and FIG. 9 show not only the log determination method executed by the log determination device 10, but also the processing procedure of the log determination program executable by the log determination device 10. These processes are not limited to the order shown in FIG. 8 and FIG. 9. That is, the order may be changed as long as there is no restriction such as a relation in which a result of the preceding step is used in a certain step. The same applies to FIG. 13 and FIG. 14 of the second embodiment, which will be described later.

The log acquisition unit 101 acquires a security log generated when the security sensor 201 mounted on each of the multiple ECUs 20 configuring the electronic control system S detects an abnormality (S101).

The log storage unit 102 stores the security log acquired by the log acquisition unit 101 (S102).

When it is the timing for determining the log in the false positive log determination unit 104 (S103: Y), for example, when the log determination process is performed at periodic timing and a certain period of time has elapsed since the log determination in the previous time, the false positive log determination unit 104 determines whether or not the security log stored in the log storage unit 102 is a false positive log (S104). Details of the processing in S104 will be described later.

Based on the determination result in S104, when the security log is determined to be a false positive log (S105: Y), the false positive information assignment unit 106 adds false positive information to the security log that has been determined to be a false positive log (S106).

Next, the transmission unit 107 transmits security logs that have not been determined to be the false positive logs and security logs that have been determined to be false positive logs and to which false positive information has been added (S107).

Referring to FIG. 9, the process of determining whether the security log is a false positive log in S104 will be explained. Although not explicitly shown in FIG. 9, the processing in FIG. 9 is repeatedly executed by the number of occurrence patterns stored in the pattern storage unit 103.

The false positive log determination unit 104 compares the multiple security logs and their occurrence order stored in the log storage unit 102 with the occurrence pattern stored in the pattern storage unit 103 (S201).

When, as a result of comparing the security logs and their occurrence patterns, multiple security logs and their occurrence order match the occurrence pattern (S202: Y), the false positive log determination unit 104 further compares the period from the earliest time information to the latest time information among the multiple security logs with the prediction period set in the occurrence pattern (S203).

Then, when the period from the earliest time information to the latest time information is within the prediction period (S203: Y), the false positive log determination unit 104 further determines whether or not the security log detected in the period from the earliest time information to the latest time information includes a security log corresponding to the non-detection log stored in the pattern storage unit 103 (S204).

When the security log corresponding to the non-detection log is not included (S204: N), the false positive log determination unit 104 determines that the multiple security logs is false positive logs (S205).

By contrast, when the multiple security logs and the occurrence orders do not match the occurrence patterns (S202: N), or when the period from the earliest time information to the latest time information is not within the prediction period (S203: N), or when the multiple security logs include a security log corresponding to a non-detection log (S204: Y), the false positive log determination unit 104 determines that the multiple security logs are not false positive logs. (S206).

Then, the false positive log determination unit 104 outputs the determination result (S207).

As described above, according to the present embodiment, it may be possible to determine that a security log generated due to vehicle maintenance is a false positive log. According to this configuration, a device analyzing attacks using security logs analyzes attacks using security logs except for security logs generated due to vehicle maintenance. It may be possible to increase the accuracy of attack analysis.

Furthermore, according to the present embodiment, by not transmitting a security log determined to be a false positive log, it may be possible to reduce the amount of communication between the log determination device and the attack analysis device.

### Second Embodiment

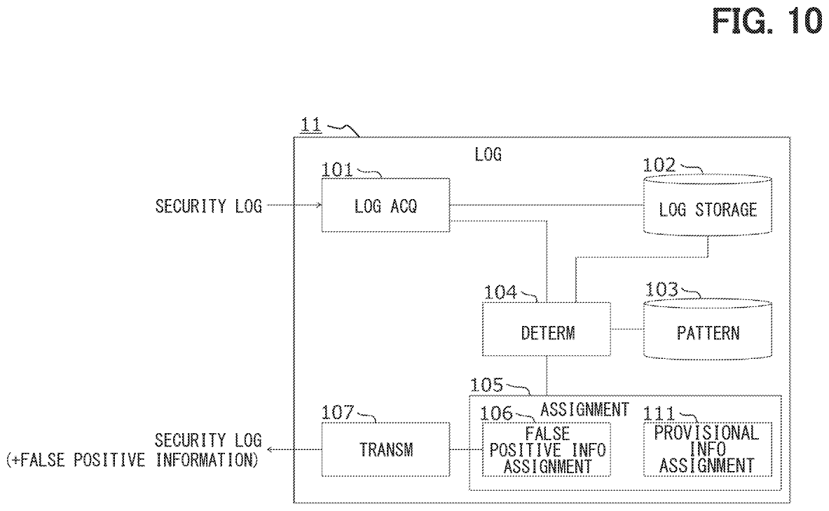

In the present embodiment, a different method from the method used in the first embodiment will be used to explain how to determine whether or not a security log is a false positive. FIG. 10 is a block diagram showing the configuration of the log determination device 11 of the present embodiment. The same components as those of the log determination device 10 of the first embodiment are denoted by the same reference numerals. The log determination device 11 of the present embodiment will be described below, focusing on differences from the first embodiment.

(Configuration of the Log Determination Device 11)

When the log acquisition unit 101 acquires a security log, the false positive log determination unit 104 sequentially determines whether or not the security log is a false positive log. In the first embodiment, the timing at which the log acquisition unit 101 acquires a new security log has been described as an example of the timing at which the log determination is performed. In the first embodiment, the false positive log determination unit 104 compares multiple security logs and the occurrence order stored in the log storage unit 102 with the occurrence patterns. The false positive log determination unit 104 determines whether or not the security logs are false positive logs depending on whether the security logs and the occurrence order completely match. In the present embodiment, it is determined whether the newly acquired security log, the security log and the occurrence order stored in the log storage unit 102 match part of the occurrence pattern at the timing when a new security log is acquired.

The false positive log determination unit 104 determines whether a newly acquired security log (referred to as an acquisition security log), the security log stored in the log storage unit 102 (referred to as a save security log), and the occurrence order match part of the occurrence pattern. When the acquisition security log, the save security log and the occurrence order match part of the occurrence pattern, the degree of matching between the acquisition security log, the save security log and the occurrence order, and the occurrence pattern is calculated. The degree of matching of the acquisition security log, the save security log and the occurrence order is calculated with respect to the occurrence pattern.

When the calculated matching degree is 100%, the false positive log determination unit 104 determines that the acquisition security log and the save security log are false positive logs.

By contrast, when the matching degree does not reach 100% within the prediction period, the false positive log determination unit 104 determines that the acquisition security log and the save security log are not false positive logs.

The information assignment unit 105 of the present embodiment implements the provisional information assignment unit 111 in addition to the false positive information assignment unit 106. When the degree of matching calculated by the false positive log determination unit 104 is higher than a predetermined threshold value, the provisional information assignment unit 111 adds provisional information indicating that there is a possibility of a false positive log to the acquisition security log and the save security log.

The term “higher than” includes both cases in which the same value as a comparison object is included and in which the same value is not included.

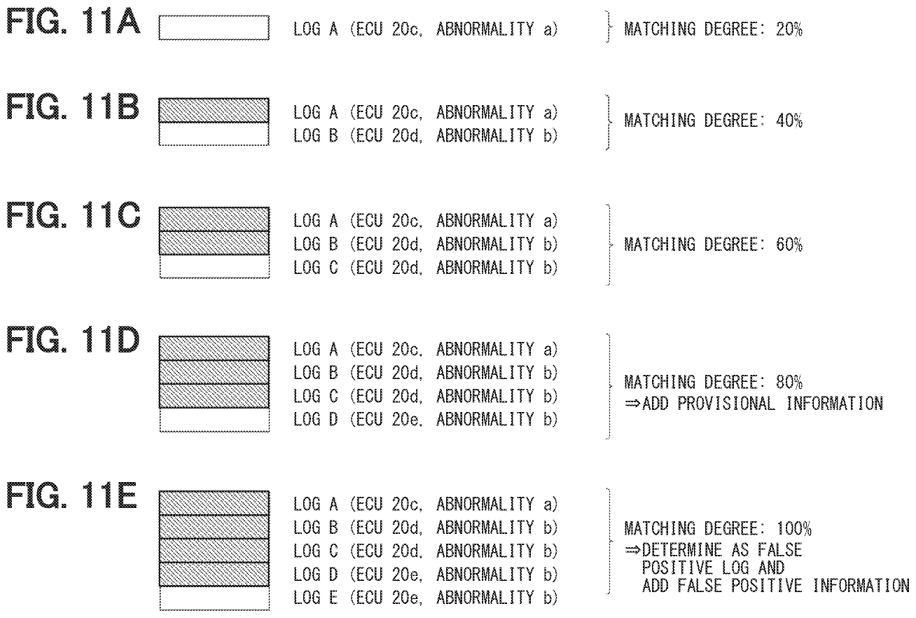

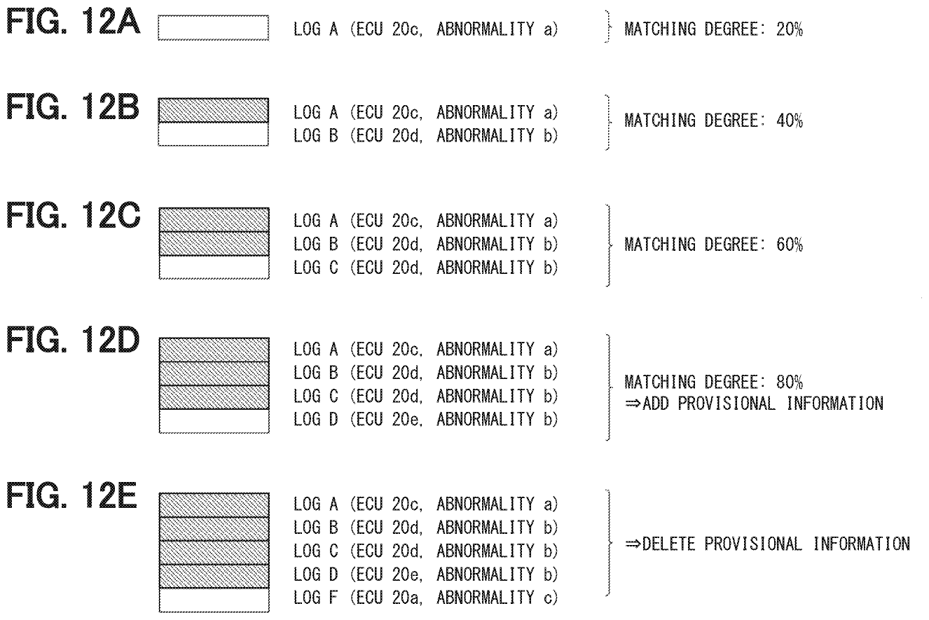

Referring to FIG. 11A to 11E and FIG. 12A to 12E, the false positive log determination unit 104 and the provisional information assignment unit 111 will be explained in more detail. FIG. 11A to 11E and FIG. 12A to 12E show a comparison between the acquisition security log and the save security log with occurrence patterns, and the degree of matching. The squares in FIG. 11A to 11E and FIG. 12A to 12E represent security logs. The white squares indicate a security log which is newly acquired by the log acquisition unit 101. The diagonally lined squares indicate security logs stored in the log storage unit 102. In the example shown below, it is assumed that the matching degree threshold is set to 70%.

FIG. 11A shows a state in which the log acquisition unit 101 acquires a log A indicating that the ECU 20c has detected an abnormality (a). The occurrence pattern of the log A matches part of the maintenance ID (0001) shown in FIG. 6. Therefore, the false positive log acquisition unit 104 calculates the degree of matching. In this example, the occurrence pattern of the maintenance ID (0001) includes a total of five sets: one set with the ECU 20c and the abnormality (a), two sets with the ECU 20d and the abnormality (b), and two sets with the ECU 20e and the abnormality (b). Therefore, since only one set out of the five sets matches, the degree of matching is equal to 20%. In this case, the degree of matching is below the matching degree threshold.

FIG. 11B shows that the log acquisition unit 101 has acquired a log B indicating that the abnormality (b) is detected at the ECU 20d. As mentioned above, the white square corresponding to the log B is a newly acquired security log. Since the log A and the log B partially match the occurrence pattern of the maintenance ID (0001), the false positive log acquisition unit 104 calculates the degree of matching. As described in FIG. 11B, the matching degree is 40%, which is below the threshold. Similarly, FIG. 11C shows a state in which the log acquisition unit 101 acquires a log C indicating that an abnormality (b) is detected at the ECU 20d. Since the logs A to C partially match the occurrence patterns of the maintenance ID (0001), the false positive log acquisition unit 104 calculates the degree of matching. In FIG. 11C, the degree of matching is 60%, which is below the threshold.

FIG. 11D shows a state in which the log acquisition unit 101 has acquired a log D indicating that an abnormality (b) is detected at the ECU 20e. Since the log A to D partially match the occurrence pattern of the maintenance ID (0001), the false positive log acquisition unit 104 calculates the degree of matching. In FIG. 11D, the matching degree is 80%, which is higher than the threshold of the matching degree. Therefore, the provisional information assignment unit 111 adds provisional information to the logs A to D. FIG. 11E shows a state in which the log acquisition unit 101 acquires a log E indicating that an abnormality (b) is detected at the ECU 20e. Since the logs A to E match the occurrence pattern of the maintenance ID (0001), the false positive log acquisition unit 104 calculates the degree of matching. In FIG. 11E, the matching degree is 100%. Therefore, the false positive log determination unit 104 determines that logs A to E are false positive logs. Then, the false positive information assignment unit 116 adds false positive information to the logs A to E.

FIG. 12A to FIG. 12D are the same as FIG. 11A to FIG. 11D, but FIG. 12E is different from FIG. 11E. FIG. 12E shows a state in which a log F indicating that an abnormality (c) is detected at the ECU 20a, instead of the log E. According to FIG. 7, the log indicating that the ECU 20a has detected the abnormality (c) corresponds to the non-detection log of the maintenance ID (0001). Therefore, in the case of FIG. 12E, the false positive log determining unit 104 determines that logs A to F are not false positive logs. The false positive log determination unit 104 deletes the provisional information added in FIG. 12D. FIG. 12E illustrates a case where a non-detection log is acquired. The same applies when a log corresponding to the log E of FIG. 11E is not acquired within the prediction period from the time of acquiring the log A.

(Operation of a Log Determination Device 11)

The operation of the log determination device 11 will be described with reference to FIG. 13 and FIG. 14. The same reference numerals as in FIG. 8 or FIG. 9 are assigned to the processes common to the log determination device 10.

FIG. 13 shows a series of processes from when the log acquisition unit 101 acquires a security log, to determining whether or not the security log is a false positive log and transmitting the security log. Unlike FIG. 8, FIG. 13 does not include the process of determining whether it is the determination timing of the security log. At S101, the log acquisition unit 101 acquires the security log. At S102, the acquired security log is stored. Then, the false positive log determination unit 104 always performs a determination (S104) as to whether the security log is a false positive log or not.

The process of determining whether or not the security log is a false positive log at S104 of FIG. 13 will be described with reference to FIG. 14.

The false positive log determination unit 104 compares the security log acquired in S101 of FIG. 13 (that is, the acquisition security log), the save security log stored in the log storage unit 102, their occurrence order, and the occurrence pattern. (S301).

When the acquisition security log, the save security log, and the occurrence order match a part of the occurrence pattern (S302: Y), the false positive log determination unit 104 further compares the period of time from the earliest time information among the save security logs to the time information of the acquisition security log with the prediction period set in the occurrence pattern (S303).

Then, when the period from the earliest time information to the time information of the acquisition security log is within the prediction period (S303: Y), the false positive log determination unit 104 further determines whether the security log detected in the period from the earliest time information to the time information of the acquisition security log includes a security log corresponding to the non-detection log (S304).

When a security log corresponding to the non-detection log is not included (S304: N), the false positive log determination unit 104 calculates the degree of matching between the acquisition security log and the save security log and the occurrence pattern (S305).

When the calculated matching degree is 100% (S306), it is determined that the acquisition security log and the save security log correspond to false positive logs (S307).

By contrast, when the calculated matching degree is not 100%, the false positive log determination unit 104 further determines whether or not the matching degree is higher than the threshold (S306).

When the degree of matching is higher than the threshold, the provisional information assignment unit 111 adds provisional information to the acquisition security log and the save security log (S309) and returns to the process of FIG. 13.

By contrast, when the degree of matching is equal to or less than the threshold, the process returns to S101 in FIG. 13.

When the period from the earliest time information of the save security log to the time information of the acquisition security log is not within the prediction period (S303: N), or when the security log corresponding to the non-detection log is included (S304: In Y), the false positive log determination unit 104 determines whether or not the provisional information is added to the determined security log (S310).

When the provisional information is added to the security log, the provisional information is deleted (S311).

The false positive log determination unit 104 determines that the acquisition security log and the save security log are not false positive logs (S312).

In S302, when the acquisition security log and the save security log do not match part of the occurrence pattern (S302: N), the false positive log determination unit 104 determines that the acquisition security log and the save security log are not false positive logs (S312).

The false positive log determination unit 104 outputs a determination result as to whether or not the security log is a false positive log (S308).

As described above, according to the present embodiment, it may be possible to determine whether or not a security log is a false positive log even when not all security logs corresponding to an occurrence pattern have been acquired.

The features of the log determination device and the like in each embodiment of the present disclosure have been described above.

Terms used in the description of each embodiment are examples and may be replaced with synonymous terms or terms having a synonymous function.

The block diagrams used for the description of the embodiments are obtained by classifying and organizing the configurations of the devices for each function. The blocks representing the respective functions may be implemented by any combination of hardware or software. Since the blocks represent the functions, such a block diagram may also be understood as disclosures of a method and a program for implementing the method.

An order of functional blocks that can be understood as processes, flows, and methods described in the embodiments may be changed as long as there are no restrictions such as a relation in which results of preceding steps are used in one other step.

The terms such as first, second, to N-th (where N is an integer) used in each embodiment are used to distinguish two or more configurations and methods of the same kind and are not intended to limit the order or superiority.

Each embodiment assumes a vehicle log determination device for determining a security log generated by a security sensor of an electronic control unit mounted in a vehicle. It also includes dedicated or general-purpose devices other than those for vehicles, except when they are used.

Examples of the form of the log determination device of the present disclosure include the following.

Examples of a form of a component include a semiconductor device, an electronic circuit, a module, and a microcomputer.

Examples of a form of a semi-finished product include an electric control unit (ECU) and a system board.

Examples of a form of a finished product include a cellular phone, a smartphone, a tablet computer, a personal computer (PC), a workstation, and a server.

In addition, the devices may include a device having a communication function or the like, and examples thereof include a video camera, a still camera, and a car navigation system.

Necessary functions such as an antenna and a communication interface may be added to the log determination device.

The log determination device of the present disclosure is assumed to be used for the purpose of providing numerous services by being used particularly on the server side. When such a service is provided, the log determination apparatus of the present disclosure is used, the method of the present disclosure is used, or/and the program of the present disclosure is executed.

In addition, the present disclosure may be implemented by not only dedicated hardware having the configurations and functions described in each embodiment but also as a combination of a program recorded in a recording medium such as a memory or a hard disk and provided to implement the present disclosure, and general-purpose hardware having a dedicated or general-purpose CPU, which can execute the program, and having a memory and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the recording medium or from a server via a communication line without using the recording medium. Consequently, as the program is upgraded, the corresponding latest function can be always provided.

The log determination device of the present disclosure is mainly intended for a device that determines a security log generated by a security sensor of an electronic control device mounted on an electronic control system mounted on an automobile but may be intended for a device that analyzes a log generated by other system or device not mounted on an automobile.

The present disclosure can be realized in various forms such as a program. The program may be stored in a computer-readable, non-transitory tangible storage medium as instructions to be executed by a computer. For example, the program may be stored in a flash memory, ROM, or the like.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

Here, the process of the flowchart or the flowchart described in this application includes a plurality of sections (or steps), and each section is expressed as, for example, S101. Further, each section may be divided into several subsections, while several sections may be combined into one section. Furthermore, each section thus configured may be referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A log determination device comprising:
a log acquisition unit that is configured to acquire a plurality of security logs each including an abnormality information indicating an abnormality detected in an electronic control system and a position information indicating a position of the abnormality in the electronic control system;
a pattern storage unit that is configured to store an occurrence pattern of a security log which is predicted to occur due to a maintenance of the electronic control system, the occurrence pattern including a plurality of sets each including a prediction abnormality information indicating an abnormality which is predicted to be detected in the electronic control system and a prediction abnormality position information indicating a position of the abnormality that is predicted to be detected in the electronic control system; and
a false positive log determination unit that is configured to compare the plurality of security logs with the occurrence pattern, to make a determination of whether or not the plurality of security logs is a false positive log generated by detecting an abnormality caused by the maintenance.

2. The log determination device according to claim 1, wherein:
the occurrence pattern includes an order of occurrence of the plurality of sets in addition to the plurality of sets; and
the false positive log determination unit compares the plurality of security logs and the occurrence order of the plurality of security logs with the occurrence pattern, and determines whether or not the plurality of security logs is the false positive log.

3. The log determination device according to claim 1, wherein:
each of the plurality of security logs includes a time information indicating a time when the abnormality has been detected;
the pattern storage unit further stores a prediction period indicating a period that is predicted from a time when the predicted abnormality is first detected to a time when the predicted abnormality is last detected; and
the false positive log determination unit further compares a period from a first time information that is an earliest time information among the time information of the security logs to a second time information that is a latest time information among the time information with the prediction period, and determines whether or not the plurality of security logs is the false positive log.

4. The log determination device according to claim 1, wherein:
each of the plurality of sets includes a prediction number of times indicating a total number of times the predicted abnormality occurs; and
the false positive log determination unit compares a total number of the security logs that have both the abnormality information and the position information in common with the prediction number of times to determine whether or not the plurality of security logs is a false positive log.

5. The log determination device according to claim 1, wherein:
the pattern storage unit includes a prediction non-detection position information indicating a position of the abnormality that is predicted not to be detected in the electronic control system due to the maintenance, and a prediction non-detection abnormality information indicating an abnormality that is predicted not to be detected at the position indicated by the prediction non-detection position information; and
the false positive log determination unit compares the plurality of security logs with the prediction non-detection abnormality information and the prediction non-detection position information, and determines whether or not the plurality of security logs is the false positive log.

6. The log determination device according to claim 1, further comprising:
a false positive information assignment unit that is configured to add a false positive information identifying the false positive log to the plurality of security logs, based on a result of the determination; and
a transmission unit that is configured to transmit the security log to which the false positive information is added.

7. The log determination device according to claim 1, wherein:
the false positive log determination unit calculates a degree of matching between the plurality of security logs and the occurrence pattern, and
the log determination device further comprising:
a provisional information assignment unit that is configured to add to the security logs a provisional information indicating a possibility that the plurality of security logs is likely to be the false positive logs in a case where the degree of matching is higher than a threshold value.

8. The log determination device according to claim 7, wherein:
each of the plurality of security logs includes a time information indicating a time when the abnormality has been detected;
the pattern storage unit stores a prediction period indicating a period that is predicted from a time when the predicted abnormality is first detected to a time when the predicted abnormality is last detected; and
in a case where the degree of the matching does not reach 100% before the prediction period elapses from an earliest time information among the time information, the false positive log determination unit determines that the plurality of security logs is not the false positive log and deletes the provisional information.

9. The log determination device according to claim 1, wherein:
the electronic control system and the log determination device are mounted on a movable object.

10. The log determination device according to claim 1, wherein:
the electronic control system is mounted on a movable object; and
the log determination device is provided outside the movable object.

11. A log determination method executable by a log determination device, the log determination device including a pattern storage unit that is configured to store an occurrence pattern of a security log which is predicted to occur due to a maintenance of an electronic control system, the occurrence pattern including a plurality of sets each including a prediction abnormality information indicating an abnormality which is predicted to be detected in the electronic control system and a prediction abnormality position information indicating a position of the abnormality that is predicted to be detected in the electronic control system, the method comprising:
acquiring a plurality of security logs each including an abnormality information indicating an abnormality detected in an electronic control system and a position information indicating a position of the abnormality in the electronic control system;
comparing the plurality of security logs with the occurrence pattern;
determining whether or not the plurality of security logs is a false positive log generated by detecting an abnormality caused by the maintenance; and
outputting a determination result.

12. A non-transitory computer-readable storage medium storing a log determination program executable by a log determination device, the log determination device including a pattern storage unit that is configured to store an occurrence pattern of a security log which is predicted to occur due to a maintenance of an electronic control system, the occurrence pattern including a plurality of sets each including a prediction abnormality information indicating an abnormality which is predicted to be detected in the electronic control system and a prediction abnormality position information indicating a position of the abnormality that is predicted to be detected in the electronic control system, the program comprising instructions of:
acquiring a plurality of security logs each including an abnormality information indicating an abnormality detected in an electronic control system and a position information indicating a position of the abnormality in the electronic control system;
comparing the plurality of security logs with the occurrence pattern;
determining whether or not the plurality of security logs is a false positive log generated by detecting an abnormality caused by the maintenance; and
outputting a determination result.

13. A log determination system comprising:
an electronic control system; and
a log determination device,
wherein:
the electronic control system includes
a log generation unit that is configured to generate a security log including an abnormality information indicating an abnormality and a position information indicating a position of the abnormality detected in the electronic control system, in a case where the abnormality has been detected in the electronic control system, and
a log transmission unit that is configured to transmit the security log to the log determination device; and
the log determination device includes
a log acquisition unit that is configured to acquire a plurality of security logs transmitted from the log transmission unit,
a pattern storage unit that is configured to store an occurrence pattern of a security log which is predicted to occur due to a maintenance of an electronic control system, the occurrence pattern including a plurality of sets each including a prediction abnormality information indicating an abnormality which is predicted to be detected in the electronic control system and a prediction abnormality position information indicating a position of the abnormality that is predicted to be detected in the electronic control system, and
a false positive log determination unit that is configured to compare the plurality of security logs with the occurrence pattern, determine whether or not the plurality of security logs is a false positive log generated by detecting an abnormality caused by the maintenance, and output a determination result.
